(19) United States
(12) Patent Application Publication
(10) Pub. No.: US 2002/0169673 A1
(43) Pub. Date: Nov. 14, 2002

(54) Point of sale enhanced manager/operator override system

(75) Inventors: Thomas Joseph Prorock, Raleigh, NC (US); William J. Noonan, Cary, NC (US)

Correspondence Address: J. Bruce Schelkopf, IBM Corp., PSG Legal Dept, Dept. 9CCA/Bldg. 002-2, P.O. Box 12195, Research Triangle Park, NC, 27709, US

(73) Assignee: International Business Machines Corporation, Armonk, NY

(21) Appl. No.: 09/853,296

(22) Filed: May 11, 2001

(51) Int. Cl. G06F 17/60

(52) U.S. Cl. 705/16; 705/18

(57) ABSTRACT

At a point of sale terminal, a biometrics device is coupled to the point of sale terminal to provide for an ability to scan a fingerprint of an authorized operator or manager. Once an authorized fingerprint is scanned, then a series of predetermined commands will automatically be performed within the point of sale terminal to implement the override function required of the manager or operator. The biometrics device replaces the need for a physical key to be used by a manager to access the point of sale terminal, and then also replaces the need for the manager to enter a keying sequence to perform the override function.

### TECHNICAL FIELD

The present invention relates in general to point of sale systems, and in particular, to point of sale systems incorporating a manager/operator override mechanism.

### BACKGROUND INFORMATION

In point of sale (“POS”) systems, there are certain conditions that require manager overrides. Some of these conditions are the voiding of certain items in a sales transaction, the amount of a price keyed is under a predefined limit, the price keyed for a refund exceeds the department limit for a negative entry type, the price keyed for a miscellaneous transaction payout exceeds the maximum limit, various coupon conditions such as count and amount per transaction, discount limit errors, the total for a tender type in a transaction exceeds the limit for that tender type, to complete a cashier loan if the limit exceeds the predefined limit, or to perform a till exchange when the till contents exceed the user defined limits. The problem is that when a manager override is required, the sales transaction is interrupted, and the time to complete the transaction is delayed. To perform the manager override, typically the following key sequence is required: press the Clear Key, insert the physical manager key, engage the manager key, press the Override Key, enter an N digit override number, and press the Enter Key. An operator override may also be required during day-to-day store operations. An operator override involves the same keyboard entries described above, but may not require the physical key to be present to perform the override transaction.

As a result, there is a need in the art for an improved method and system for more efficiently conducting manager/operator overrides at point of sale terminals.

### SUMMARY OF THE INVENTION

The present invention addresses the foregoing need by implementing a biometrics reader device, such as a fingerprint reader to identify the manager and automatically perform all of the key sequences involved to complete a manager override transaction. As a result, a single fingerprint scan acts as both the physical key and the keying sequence to perform the override procedure.

One advantage of the present invention is that it improves upon a disadvantage of current POS systems by eliminating the possibility of theft or loss of the override key or an unauthorized duplication of such key.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a prior art process for implementing a manager override in a point of sale system;

FIG. 2 illustrates a process for implementing a manager/operator override system in accordance with the present invention;

FIG. 3 illustrates a prior art point of sale system; and

FIG. 4 illustrates a point of sale system in accordance with the present invention.

### DETAILED DESCRIPTION

In the following description, numerous specific details are set forth such as specific biometrics devices, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

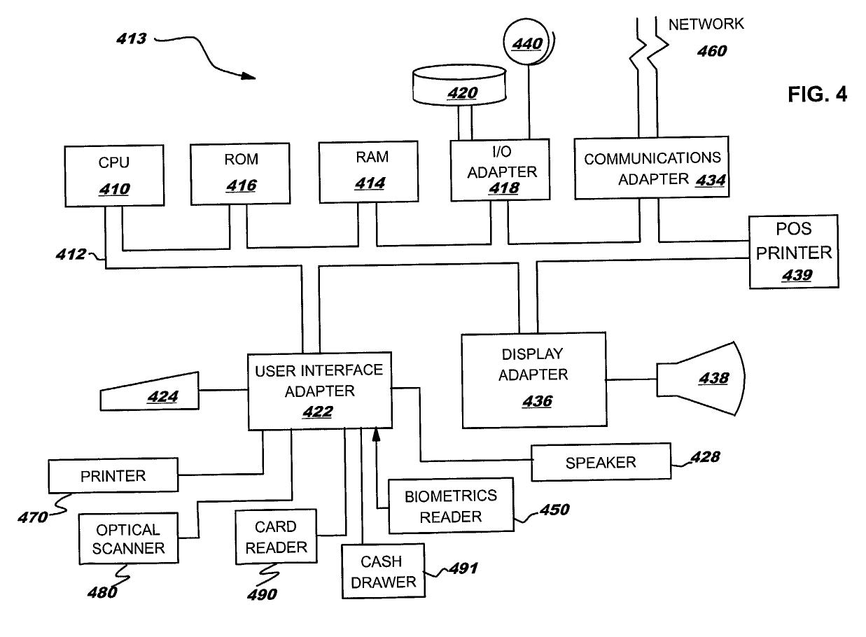

The present invention uses biometrics device, such as a biometrics fingerprint reader device, for the purpose of identifying an authorized manager or operator, and automatically commencing a sequence of software commands within the point of sale (“POS”) system. Referring to FIG. 4, there is illustrated an exemplary point of sale system 413 in accordance with the present invention. The system has a central processing unit (CPU) 410, which is coupled to various other components by system bus 412. Read only memory (“ROM”) 416 is coupled to the system bus 412 and includes a basic input/output system (“BIOS”) that controls certain basic functions of the data processing system 413. Random access memory (“RAM”) 414, I/O adapter 418, and communications adapter 434 are also coupled to the system bus 412. I/O adapter 418 may be a small computer system interface (“SCSI”) adapter that communicates with a disk storage device 420. Communications adapter 434 interconnects bus 412 with an outside network enabling the data processing system to communicate with other such systems. Input/Output devices are also connected to system bus 412 via user interface adapter 422 and display adapter 436. Keyboard 424, Printer 470, optical scanner 480, credit card reader 490, cash drawer 491 and speaker 428 may all be interconnected to bus 412 via user interface adapter 422. Display monitor 438 is connected to system bus 412 by display adapter 436.

Implementations of the invention include implementations as a computer system programmed to execute the method or methods described herein, and as a computer program product. According to the computer system implementation, sets of instructions for executing the method or methods are resident in the random access memory 414 of one or more computer systems configured generally as described above. Until required by the computer system, the set of instructions may be stored as a computer program product in another computer memory, for example, in disk drive 420 (which may include a removable memory such as an optical disk or floppy disk for eventual use in the disk drive 420). Further, the computer program product can also be stored at another computer and transmitted when desired to the user's POS terminal by a network 460 or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

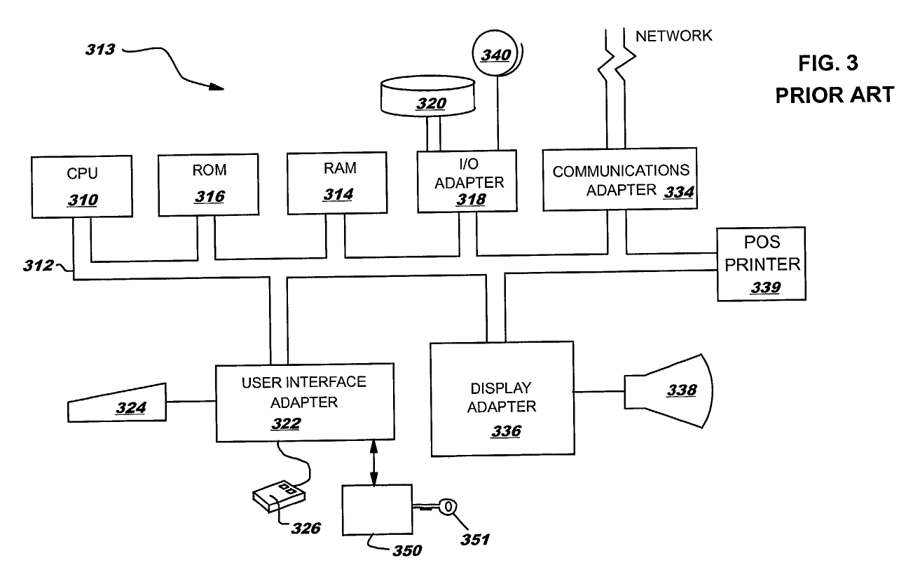

The present invention uses a biometrics reader device 450 coupled to the user interface adapter 422, which in one embodiment of the present invention may be a fingerprint reader device, to identify the manager, and when the system determines that the manager has accessed the system, to automatically perform all of the key sequences involved to complete a manager override transaction. In summary, one fingerprint scan acts as both the physical key previously required as described above with respect to FIG. 3, and the keying sequence to perform an override procedure. Such a fingerprint reader device could be the Secure Touch 2000, manufactured by Biometrics Access Corporation, as disclosed at: http://www.biometricaccess.com/securetouch_{—}2000.htm, which is hereby incorporated by reference herein.

Note, any other type of biometrics device could also be used such as a retinal scanner, voice recognition device, face recognition device, signature recognition, hand size, hand print, etc.

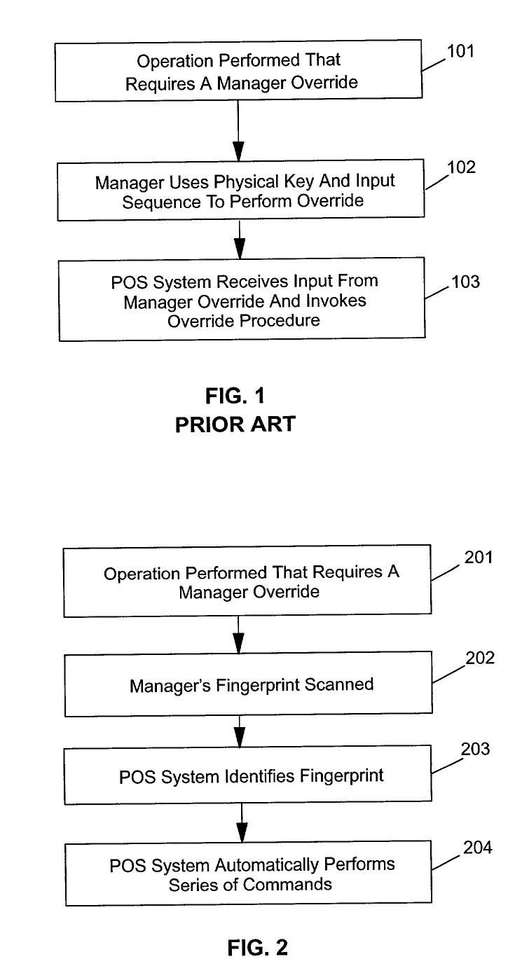

Referring to FIG. 2, the present invention operates as follows. A cashier operating the point of sale terminal 413 may perform some type of operation on the point of sale terminal 413 that requires a manager's override (Step 201). Note, any operator override function can also be performed in accordance with the present invention. Point of sale terminal 413 then waits to read the input from the biometric fingerprint device 450. The manager is notified (e.g., via pager, e-mail, instant message, cell phone, intercom) that an override is required and then scans their fingerprint on the biometric fingerprint device 450 in step 202. The point of sale system 413 receives the input that the fingerprint was scanned and is in fact associated with a manager that is authorized to perform the override transaction in step 203. The point of sale terminal 413 then automatically invokes the commands necessary to complete the manager override procedure in step 204. This procedure may be any number of commands and keying sequences, as described above with respect to FIG. 1.

Since the point of sale terminal 413 is waiting on an indication from a biometric fingerprint device 450, it is possible to receive that indication even from a remote fingerprint reader coupled to the terminal 413 through a data processing network 460. In such a way, the manager may be at any location near a terminal on the network, and upon receiving notification that an override is required, the manager can then use the fingerprint reader at a remote location to complete the override without the need to physically walk out to the point of sale terminal 413 that requires attention. The fingerprint reader can be attached to or integrated into other devices associated with the POS system, such as attached to a check verification device. The fingerprint reader can also be located remotely such as in a back office of a store.

Benefits to the present invention are that it saves overall transaction time when a manager/operator override is required, it reduces the possibility of keying errors when performing the overrides, it simplifies store operations and reduces training costs/complexity by reducing the override procedure to a single fingerprint scan, and it uses existing hardware in the store in that there is no need to purchase additional devices to perform automatic overrides. Additionally, the present invention may also make use of fingerprint readers that are already associated with existing check authorization devices.

Although the present invention has been described above with respect to POS systems, it should be clear to those skilled in the art that the ideas and concepts disclosed herein can also apply to any systems that previously required a key and a keying sequence to complete a transaction. For example, the present invention could be utilized within banking/financial institutions that may require a key to approve transactions for large sums of money, or to authorize the transfer of large sums of money. Additionally, the present invention can be utilized within military systems that may require a key to perform a critical procedure.

Although the present invention and its advantages have been described in detail, it should be understood that various changes, substitutions and alterations can be made herein without departing from the spirit and scope of the invention as defined by the appended claims.

What is claimed is:

1. A method for performing an override function in a point of sale (“POS”) terminal, comprising the steps of:
receiving a first input from an operator of the POS terminal;
determining that the first input from the operator of the POS terminal requires an override procedure before further operation of the POS terminal can proceed;
notifying the operator of the POS terminal that the override procedure is required;
receiving a second input from a biometrics device coupled to the POS terminal, wherein the second input is produced in response to a biometric reading by the biometrics device of a person;
comparing the second input to a list of authorized inputs; and
automatically performing the override procedure if the second input matches an authorized input in the list of authorized inputs.

2. The method as recited in claim 1, further comprising the step of:
continuing further operation of the POS terminal after the override procedure has been performed.

3. The method as recited in claim 2, wherein the override procedure comprises a series of commands operated within the POS terminal.

4. The method as recited in claim 3, wherein the second input matches the authorized input when the person is authorized to commence the override procedure.

5. The method as recited in claim 2, wherein the biometrics device is remotely coupled to the POS terminal through a computer network coupled to the POS terminal.

6. A point of sale (“POS”) terminal, comprising:
an input device for receiving a first input from an operator of the POS terminal;
circuitry for determining that the first input from the operator of the POS terminal requires an override procedure before farther operation of the POS terminal can proceed;
an output device for notifying the operator of the POS terminal that the override procedure is required;
a biometrics device;
an input/output adaptor for receiving a second input from the biometrics device, wherein the second input is produced in response to a biometric reading by the biometrics device of a person;
circuitry for comparing the second input to a list of authorized inputs; and
circuitry for automatically performing the override procedure if the second input matches an authorized input in the list of authorized inputs.

7. The POS terminal as recited in claim 6, further comprising:
circuitry for continuing further operation of the POS terminal after the override procedure has been performed.

8. The POS terminal as recited in claim 6, wherein the override procedure comprises a series of software commands operated withing the POS terminal.

9. The POS terminal as recited in claim 6, wherein the second input matches the authorized input when the person is authorized to commence the override procedure.

10. A method for reconfiguring a point of sale (“POS”) terminal, comprising the steps of:
replacing an input device coupled to the POS terminal that outputs an authorization signal in response to a manual insertion of a physical key with a biometrics device that outputs the authorization signal in response to a biometric reading of a person; and
reprogramming software in the POS terminal to automatically perform a series of override commands upon receipt of the authorization signal from the biometrics device.

11. A computer program product operable for performing an override function in a point of sale (“POS”) terminal, the computer program product adaptable for storage on a computer storage medium, comprising the program steps of:
receiving a first input from an operator of the POS terminal;
determining that the first input from the operator of the POS terminal requires an override procedure before further operation of the POS terminal can proceed;
notifying the operator of the POS terminal that the override procedure is required;
receiving a second input from a biometrics device coupled to the POS terminal, wherein the second input is produced in response to a biometric reading by the biometrics device of a person;
comparing the second input to a list of authorized inputs; and
automatically performing the override procedure if the second input matches an authorized input in the list of authorized inputs.

12. The computer program product as recited in claim 11, further comprising the program step of:
continuing further operation of the POS terminal after the override procedure has been performed.

13. The computer program product as recited in claim 12, wherein the override procedure comprises a series of commands operated within the POS terminal.

14. The computer program product as recited in claim 13, wherein the second input matches the authorized input when the person is authorized to commence the override procedure.

15. The computer program product as recited in claim 12, wherein the biometrics device is remotely coupled to the POS terminal through a computer network coupled to the POS terminal.
